(19) United States
(12) Patent Application Publication
(10) Pub. No.: US 2007/0085880 A1
(43) Pub. Date: Apr. 19, 2007

(54) Hybrid image forming apparatus

(75) Inventors: Sung-wook Kang, Seoul (KR); Heon-soo Park, Seongnam (KR); Su min Lim, Seongnam (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/505,419

(22) Filed: Aug. 17, 2006

(30) Foreign Application Priority Data
Oct. 15, 2005 (KR) 2005-97267

(51) Int. Cl. B41J 2/14; B41J 2/16

(52) U.S. Cl. 347/49

(57) ABSTRACT

A hybrid image forming includes a first printing unit detachably mountable in the hybrid image forming apparatus and having a first printhead to print an image while performing a reciprocating motion in a width direction of a printing medium, and a second printing unit detachably mountable in the hybrid image forming apparatus and having a length at least as long as the width of the printing medium, and a mounting part to which each of the first printing unit and the second printing unit is detachably mountable.

### CROSS-REFERENCE TO RELATED APPLICATIONS

This application claims priority under 35 U.S.C. §119(a) from Korean Patent Application No. 10-2005-0097267, filed on Oct. 15, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to a hybrid image forming apparatus that can be used in a variety of printing environments.

2. Description of the Related Art

An “image forming apparatus” includes an inkjet image forming apparatus, photo printers, LED printers, digital copiers, and electrophotographic image forming apparatus. A user selects and uses an image forming apparatus appropriate for a desired printing environment among the variety of image forming apparatuses. For example, where a user desires to print a photo, the user uses a photo printer or a shuttle type inkjet image forming apparatus. In contrast, where a user desires high-speed printing, the user uses a line printing type inkjet image forming apparatus or an electrophotographic image forming apparatus. The shuttle type inkjet image forming apparatus is an apparatus for firing ink using a printhead spaced apart from a printing medium and performing a reciprocating motion in a direction perpendicular to a delivery direction of the printing medium to form an image. The line printing type inkjet image forming apparatus is an apparatus for firing ink using a printhead that has a nozzle unit having a length at least as long as the width of a printing medium to form an image.

However, though the shuttle type inkjet image forming apparatus and the photo printers can realize a high resolution printing quality, they cannot meet a printing speed in the case where a high-speed printing is desired. In contrast, the line printing type inkjet image forming apparatus and the electrophotographic image forming apparatus can realize a high-speed printing, but they have difficulty in realizing a desired resolution in the case where the desired resolution is higher than an actual resolution supported by a printhead thereof. Therefore, development of an image forming apparatus that can provide two or more functions (e.g., high-speed printing and a high resolution printing) in a single image forming apparatus is highly desired.

### SUMMARY OF THE INVENTION

The present general inventive concept provides an image forming apparatus that can be used in a variety of printing environments.

The present general inventive concept also provides an image forming apparatus that can be used in each of two or more printing environments.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a hybrid image forming apparatus, including a first printing unit detachably mountable in the hybrid image forming apparatus and having a first printhead to print an image while performing a reciprocating motion in a width direction of a printing medium, a second printing unit detachably mountable in the hybrid image forming apparatus and having a second printhead of a length at least as long as the width of the printing medium, and a mounting part to which each of the first printing unit and the second printing unit is detachably mountable.

The first printing unit may be detachably mounted in the mounting part to be moved in the width direction of the printing medium, and may include a carriage in which the first printhead is mounted, a guide shaft coupled to the carriage to guide a reciprocating motion of the carriage, and a carriage moving unit to reciprocally-move the carriage in the width direction of the printing medium.

The carriage moving unit may include a carriage moving motor, a carriage moving roller to rotate by receiving a rotational force from the carriage moving motor, and a carriage moving belt having one side to which the carriage is coupled to rotate on a continuous circuit supported by the carriage moving roller.

The apparatus may further include a connector located in the mounting part and compatible with each of the first printing unit and the second printing unit to detect which of the first and second printing units is mounted in the mounting part when one of the first printing unit and the second printing unit is mounted in the mounting part.

The foregoing and/or other aspects and utilities of the present general inventive concept may also be achieved by providing a hybrid image forming apparatus, including a printhead unit detachably mountable in the hybrid image forming apparatus and having a printhead to fire ink onto a printing medium to print an image, an image forming unit detachably mountable in the hybrid image forming apparatus to print an image on the printing medium in an electrophotographic manner, and a mounting part to which each of the printhead unit and the image forming unit is detachably mountable.

The printhead may have a length at least as long as a width of the printing medium.

The printhead may print the image while performing a reciprocating motion in the width direction of the printing medium.

The printhead unit may be detachably mounted in the mounting part to be moved in the width direction of the printing medium, and may include a carriage in which the printhead is mounted, a guide shaft coupled to the carriage to guide a reciprocating motion of the carriage, and a carriage moving unit to reciprocally-move the carriage in the width direction of the printing medium.

The carriage moving unit may include a carriage moving motor, a carriage moving roller to rotate by receiving a rotational force from the carriage moving motor, and a carriage moving belt having one side to which the carriage is coupled and to rotate on a continuous circuit supported by the carriage moving roller.

The apparatus may further include a connector located in the mounting part and compatible with each of the printhead unit and the image forming unit to detect which of the printhead unit and the image forming unit is mounted in the mounted part when one of the printhead unit and the image forming unit is mounted in the mounting part.

The foregoing and/or other aspects and utilities of the present general inventive concept may also be achieved by providing a hybrid image forming apparatus, including a mounting unit shaped to individually-accommodate each of a plurality of printing units having different printing mechanisms, and a detecting unit to detect when any of the plurality of printing units is mounted to the mounting unit.

The plurality of printing units may include a shuttle-type printhead unit, a line-type printhead unit, and an electrophotographic image forming cartridge. When one type of printing unit is mounted to the mounting unit, the detecting unit may detect whether the one type of printing unit is the shuttle-type printhead unit, the line-type printhead unit, or the electrophotographic image forming cartridge. A length and a width of the mounting unit may each be greater than lengths and widths of the shuttle-type printhead unit, the line-type printhead unit, and the electrophotographic image forming cartridge. A height of the mounting unit may be shorter than heights of each of the array-type printhead unit, the shuttle-type printhead unit, and the electrophotographic imaging cartridge.

The mounting unit may include four side walls and a space defined by the four side walls, and the mounting unit may individually-accommodate each of the plurality of printing units within the space. The detecting unit may include a first detecting part disposed on the mounting unit, and a second detecting part disposed on a printing unit mounted in the mounting unit to communicate with the first detecting part. The hybrid image forming apparatus may further include a connecting unit to individually-connect each of the plurality of printing units to the mounting unit. The detecting unit may be the connecting unit.

The foregoing and/or other aspects and utilities of the present general inventive concept may also be achieved by providing a hybrid image forming apparatus, including a mounting unit to accommodate two or more types of printing units having different printing mechanisms, and a detecting unit to detect the type of the two or more types of printing units. The detecting unit may detect whether the type of the two or more types of printing units is a shuttle-type printhead unit, a line-type printhead unit, or an electrophotographic image forming cartridge.

The foregoing and/or other aspects and utilities of the present general inventive concept may also be achieved by providing a hybrid image forming method, including removing a first printing unit having a first printing mechanism from a mounting unit of a hybrid image forming apparatus, mounting a second printing unit having a second printing mechanism different from the first printing mechanism to the mounting unit, and forming an image on a printing medium using the second printing unit mounted to the mounting unit.

The first printing unit may be a shuttle-type printhead unit, and the second printing unit may be a line-type printhead unit or an electrophotographic image forming unit. The first printing unit may be the line-type printhead unit, and the second printing unit may be the shuttle-type printhead unit or the electrophotographic image forming unit. The first printing unit may be the electrophotographic image forming unit, and the second printing unit may be the line-type printhead unit or the shuttle-type printhead unit. The method may further include detecting when the second printing unit is mounted to the mounting unit before the forming of the second image using a detecting unit of the hybrid image forming apparatus. The method may further include detecting whether the second printing unit is a shuttle-type printhead unit, a line-type printhead unit, or an electrophotographic image forming unit using the detecting unit of the hybrid image forming apparatus.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic view illustrating a hybrid image forming apparatus, according to an embodiment of the present general inventive concept;

FIG. 2 is a view illustrating a construction of a hybrid image forming apparatus, according to an embodiment of the present general inventive concept;

FIG. 3 is a perspective view illustrating a first printhead unit of the hybrid image forming apparatus illustrated in FIG. 2;

FIG. 4 is a sided sectional view illustrating the first printhead unit of FIG. 3 mounted in a mounting part;

FIG. 5 is a perspective view illustrating a second printhead unit of the hybrid image forming apparatus illustrated in FIG. 2; and

FIG. 6 is a view illustrating an electrophotographic image forming unit, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. In the drawings, thicknesses of lines and sizes of elements therein may be exaggerated for clarity and convenience.

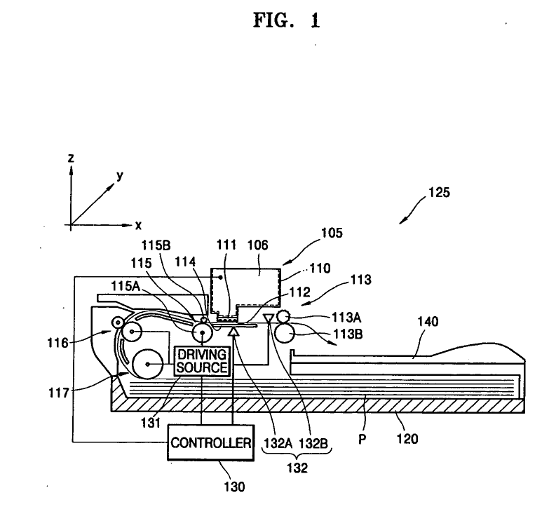

FIG. 1 is a schematic view illustrating a hybrid image forming apparatus 125, according to an embodiment of the present general inventive concept.

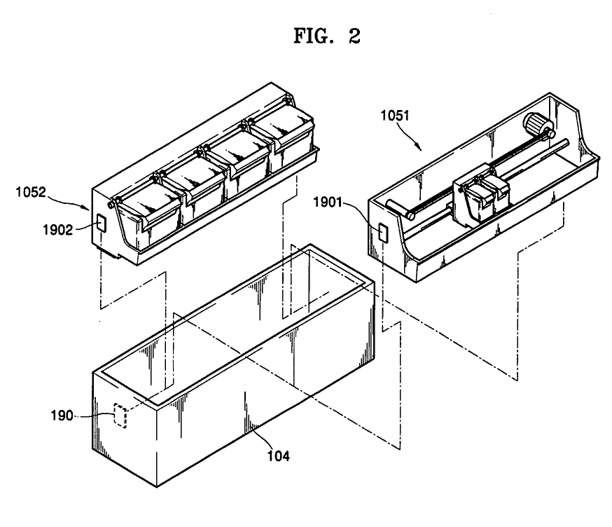

Referring to FIG. 1, the apparatus 125 includes a paper-feed cassette 120, a printing unit 105, a support member 114 positioned to face the printing unit 105, a defective nozzle detector 132 to detect a defective nozzle of a nozzle unit 112, a printing medium delivering unit to deliver a printing medium P in a first direction (x-direction), and a stacking part 140 to stack the printing medium P therein after the printing medium P is discharged. Also, the apparatus 125 includes a controller 130 to control functions and operations of respective elements of the apparatus 125. Though not illustrated in FIG. 1, the apparatus 125 includes a mounting part in which the printing unit 105 is detachably mounted (see, for example, mounting part 104 of FIG. 2).

The printing medium P is stacked in the paper-feed cassette 120. The printing medium P stacked in the paper-feed cassette 120 is delivered to the stacking part 140 by way of a printhead 111 by the printing medium delivering unit. Here, the stacking part 140 is a part (e.g., a paper-discharging tray) that stacks the printing medium P therein after the printing medium P is discharged.

The printing medium delivering unit is a unit that delivers the printing medium P stacked in the paper-feed cassette 120 along a predetermined path. The printing medium delivering unit includes a pickup roller 117, auxiliary rollers 116, feeding rollers 115, and discharging rollers 113. The printing medium delivering unit is driven by a driving source 131, such as a motor, to deliver the printing medium P along the predetermined path. The operation of the driving source 131 is controlled by the controller 130.

The pickup roller 117 is installed on one side of the paper-feed cassette 120 to pick up and feed the printing medium P stacked in the paper-feed cassette 120 sheet by sheet. The feeding rollers 115 are installed on an entry side of the printhead 111 to deliver the printing medium P fed by the pickup roller 117 to the printhead 111. The feeding rollers 115 include a driving roller 115A to provide a delivering force by which the printing medium P is delivered and an idle roller 115B elastically engaged with the driving roller 115A. A pair of the auxiliary rollers 116 to deliver the printing medium P can be further installed between the pickup roller 117 and the feeding rollers 115.

The discharging rollers 113 are installed on an exit side of the printhead 111 to discharge the printing medium P including the printed image out of the image forming apparatus 125. The discharging rollers 113 include a star wheel 113A installed in a width direction of the printing medium P and a support roller 113B positioned to face the star wheel 113A to support a backside of the printing medium P The star wheel 113A is designed to prevent the printing medium P that is delivered below the nozzle unit 112 from contacting the nozzle unit 112 or a lower surface of a body 110 of the printing unit 105, and/or to prevent an interval between the printing medium P and the nozzle unit 112 from changing. The star wheel 113A is installed such that at least a predetermined portion of the star wheel 113A protrudes more than the nozzle unit 112 to point-contact an upper surface of the printing medium P. The printing medium P discharged from the image forming apparatus 125 is stacked in the stacking part 140.

The support member 114 is located on a lower side of the printhead 111 so that the nozzle unit 112 and the printing medium P may maintain a predetermined interval therebetween, and supports the backside of the printing medium P delivered by the printing medium delivering unit. The interval between the nozzle unit 112 and the printing medium P may be, for example, about 0.5 to about 2.5 mm. In the case where an electrophotographic image forming unit (such as the electrophotographic image forming unit 200 of FIG. 6) is mounted in the mounting part as the printing unit 105, a support member 114 in the form of a transfer roller may be used so that an image is easily transferred to the printing medium P.

The defective nozzle detector 132 detects a defective nozzle generated during a manufacturing process or while a printing operation is performed. “Defective nozzle” refers to a nozzle that cannot normally fire ink, such as a dead nozzle that cannot fire ink, and a weak nozzle in which a nozzle function is weakened. That is, the defective nozzle is generated when ink is not fired from the nozzle or when a smaller quantity of ink is fired as compared to a normal nozzle.

The defective nozzle may be generated during the manufacturing process of the printhead 111 or while a printing operation is performed. Defective nozzle information generated during the manufacturing process is separately stored in a memory (not illustrated) provided to the printhead 111. The defective nozzle information is delivered to the image forming apparatus 125 when the printhead 111 is mounted in the mounting part of the image forming apparatus 125.

For example, the defective nozzle detector 132 may have an optical sensor. The optical sensor may include a light-emitting sensor 132A (e.g., a light-emitting diode) to illuminate light onto the nozzle unit 112 or the printing medium P, and a light-receiving sensor 132B to receive the light reflected from the nozzle unit 112 or the printing medium P. The defective nozzle detector 132 detects whether the defective nozzle is generated using an output signal from the light-receiving sensor 132B. Information regarding the generation of the defective nozzle is delivered to the controller 130. Here, the light-emitting sensor 132A and the light-receiving sensor 132B may be integrally formed or separately formed. Since the construction and the operation of the optical sensor itself are well known to those skilled in the art, detailed descriptions thereof will be omitted.

The printing unit 105 fires ink onto the printing medium P to print the image thereon. The printing unit 105 includes the body 110, the printhead 111 located on one side of the body 110, the nozzle unit 112, and a carriage 106 in which the body 110 is mounted. The body 110 may be mounted as a cartridge in the carriage 106. The printing unit 105 may be detachably mounted in the mounting part. That is, at least two printing units 105 having different driving mechanisms may be individually detachably mounted in the mounting part. Therefore, a user can mount a first printing unit 105 appropriate for a first desired printing environment in the mounting part of the image forming apparatus 125, or alternatively the user can mount a second printing unit 105, different from the first printing unit 105, appropriate for a second desired printing environment in the mounting part of the same image forming apparatus 125. Thus, functions of at least two image forming apparatuses can be realized with a single image forming apparatus 125.

The printing unit 105 may have a shuttle type printhead, a line printing type printhead, or an electrophotographic cartridge. Thus, the term “printing unit” refers to a shuttle type printhead unit, a line printing type printhead unit, and an electrophotographic image forming cartridge. In other words, the printing unit 105 may include one or more printing units having different printing mechanisms, such as a shuttle-type printing mechanism, a line-type printing mechanism, and/or an electrophotographic printing mechanism.

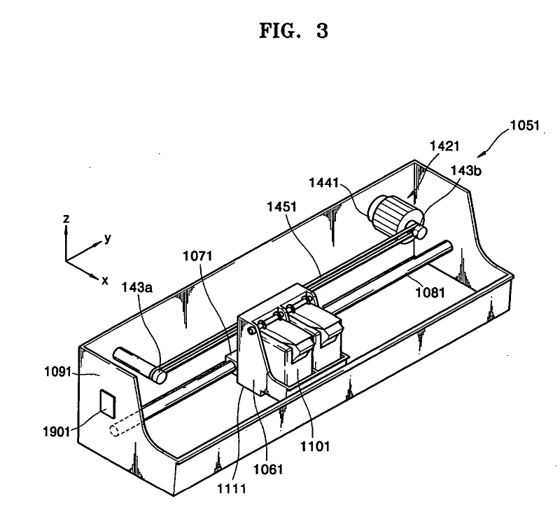

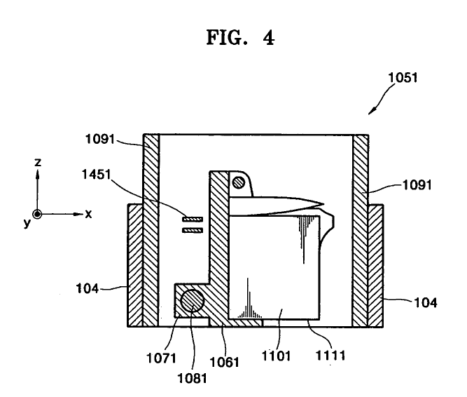

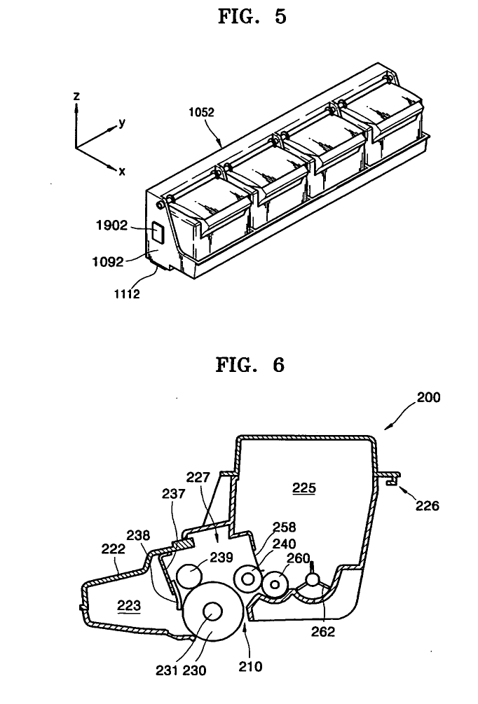

FIG. 2 is a view illustrating a construction of a hybrid image forming apparatus, according to an embodiment of the present general inventive concept. FIG. 3 is a perspective view illustrating a first printhead unit 1051 of the hybrid image forming apparatus illustrated in FIG. 2. FIG. 4 is a side sectional view illustrating the first printhead unit 1051 of FIG. 3 mounted in a mounting part 104. FIG. 5 is a perspective view illustrating a second printhead unit 1052 of the hybrid image forming apparatus illustrated in FIG. 2. FIG. 6 is a view illustrating an electrophotographic image forming unit 200, according to an embodiment of the present general inventive concept.

Referring to FIG. 2, the first and second printhead units 1051 and 1052 are individually detachably mountable in the mounting part 104 located on one side of the image forming apparatus 125. However, the first printhead unit 1051, the second printhead unit 1052, or the electrophotographic image forming unit 200 (see FIG. 6) can be detachably mounted in the mounting part 104.

Referring to FIGS. 2, 3, and 5, the first printhead unit 1051 and the second printhead unit 1052, each to fire ink onto a printing medium to print an image, may each be individually detachably mounted in the mounting part 104.

Referring to FIGS. 3 and 4, the first printhead unit 1051 has a shuttle-type printhead 1111 to print an image while performing a reciprocating motion in a width direction of the printing medium. That is, the first printhead unit 1051 is spaced at a predetermined interval from the printing medium and performs a reciprocating motion in a direction perpendicular to a delivery direction of the printing medium to fire the ink using the printhead 1111 onto the printing medium.

The first printhead unit 1051 fires the ink onto the printing medium to print an image. The first printhead unit 1051 includes a body 1101, the shuttle-type printhead 1111 located on a lower surface of the body 1101, and a carriage 1061 in which the body 1101 is mounted. The body 1101 having the printhead 1111 is mounted as a cartridge in the carriage 1061, which is reciprocated in the width direction of the printing medium by a carriage moving unit 1421. Also, though not illustrated, a cable to deliver a driving signal from the controller 130, power, and printing data therethrough is connected to the printhead 1111. The cable may be a flexible cable, such as a flexible printed circuit (FPC) or a flexible flat cable (FFC).

As illustrated in FIGS. 3 and 4, the body 1101 is mounted in the carriage 1061. The printhead 1111 is mounted in the carriage 1061 as a cartridge connected to the body 1101. The carriage moving unit 1421 reciprocates the carriage 1061 in a main scanning direction (corresponding to the width direction of the printing medium). The carriage moving unit 1421 includes a carriage moving motor 1441, carriage moving rollers 143a and 143b, and a carriage moving belt 1451. The carriage moving motor 1441 is installed in a head frame 1091. The carriage moving roller 143b is connected to the carriage moving belt 1441 and the carriage moving roller 143a is installed in the head frame 1091. The carriage moving belt 1451 rotates on a continuous circuit supported by the carriage moving rollers 143a and 143b and driven by the carriage moving unit 1421. The carriage 1061 is coupled to the carriage moving belt 1451. The carriage 1061 is moved to a predetermined position according to a control signal transmitted to the carriage moving motor 1441 from the controller 130. The reciprocating motion of the carriage 1061 is guided by a guide shaft 1081. The guide shaft 1081 is installed in the head frame 1091 to guide the reciprocating motion of the carriage 1061 driven by the carriage moving motor 1441. A coupling portion 1071 to couple to the guide shaft 1081 to the carriage 1061 is formed on one side of the carriage 1061. The coupling portion 1071 is formed on the one side of the carriage 1061 such that the guide shaft 1081 passes through the coupling portion 1071. The guide shaft 1081 is inserted into the coupling portion 1071 having a cavity therein to guide the reciprocating motion of the carriage 1061.

A connector 1901 to receive a control signal or power from the image forming apparatus 125 is provided on one side of the first printhead unit 1051. Also, referring to FIGS. 2 and 3, the mounting part 104 has a connector 190 compatible with the first printhead unit 1051 and the second printhead unit 1052 to detect which of the first and second printhead units 1051 and 1052 is mounted thereon when one of the first printhead unit 1051 and the second printhead unit 1052 is mounted in the mounting part 104. Therefore, when one of the first printhead unit 1051 and the second printhead unit 1052 is mounted in the mounting part 104, the connector 1901 or 1902 provided on the first printhead unit 1051 or the second printhead unit 1052, respectively, is coupled to the connector 190 provided on the mounting part 104 to detect which of the first and second printhead units 1051 and 1052 is mounted therein.

Referring to FIGS. 2 and 5, the second printhead unit 1052 is mounted in the mounting part 104 in substitution for (i.e., instead of or to replace) the first printhead unit 1051, and has a line-type printhead 1112 of a length at least as long as the width of the printing medium. The line-type printhead 1112 is installed in a direction parallel to the width direction of the printing medium P. The line-type printhead 1112 may use thermal energy or a piezo element as a driving source to fire the ink, and may be manufactured to have a high resolution through a semiconductor manufacturing process, such as etching, deposition, and sputtering. As described in association with the connector 1901 of the first printhead unit 1051, a connector 1902 to receive a control signal or power from the image forming apparatus 125 is provided on one side of a head frame 1092 of the second printhead unit 1052. Since the construction and the operation of the connector 1902 are similar to those of the connector 1901 in the first printhead unit 1051, detailed descriptions thereof will be omitted.

Unlike the embodiment illustrated in FIGS. 2 through 5, an image forming unit to print an image on a printing medium in an electrophotographic manner can be mounted in the mounting part 104 as opposed to the first and second printhead units 1051 and 1052.

Referring to FIGS. 2 and 6, the electrophotographic image forming unit 200 is formed as a cartridge that is detachably mountable in the mounting part 104. The electrophotographic image forming unit 200 includes a housing 222. The housing 222 may have a photosensitive body 230, a charging roller 239, a cleaning member 238, a developing roller 240, a toner layer regulator 258, a supplying roller 260, and an agitator 262 therein. Also, an opening 210 to expose a predetermined portion of the photosensitive body 230 to an outside of the electrophotographic image forming unit 200 is provided in one side of the housing 222.

A waste toner storage 223 to store waste toner separated from the photosensitive body 230 by the cleaning member 238, and a toner storage 225 to store toner, which is a developer, are formed inside of the housing 222. When all of the toner stored in the toner storage 225 is exhausted, the image forming unit 200 is replaced by a new image forming unit 200. Alternatively, the image forming unit 200 may be refilled with toner. A knob 226 to mount the image forming unit 200 in the mounting part 104 may be provided on one side of the image forming unit 200.

The photosensitive body 230 is installed such that a predetermined portion of an outer periphery thereof is exposed to the outside of the electrophotographic image forming unit 200. The photosensitive body 230 is coupled to one axis 231 to rotate in a predetermined direction. A photoconductive material layer is coated on the outer periphery of a cylindrical metal drum to form the photosensitive body 230. The photosensitive body 230 is charged to a predetermined potential by the charging roller 239, and an electrostatic latent image that corresponds to a desired image is formed by light illuminated according to a computer signal from an optical scanning unit (not illustrated).

The charging roller 239 charges the photosensitive body 230 to a uniform potential before light is illuminated from the optical scanning unit. The charging roller 239 supplies a charge to the photosensitive body 230 while rotating in a contact or non-contact state with respect to the outer periphery of the photosensitive body 230 to provide the outer periphery of the photosensitive body 230 with a uniform potential. A charging bias voltage to charge the outer periphery of the photosensitive body 230 to a uniform potential is applied to the charging roller 239. A corona discharger (not illustrated) can be adopted instead of the charging roller 239.

The developing roller 240 attaches the toner received inside of the image forming unit 200 on an outer periphery of the developing roller 240 to supply the toner to the photosensitive body 230. The developing roller 240 receives the toner in a solid powder state and supplies the toner to the electrostatic latent image formed on the photosensitive body 230 to develop a toner image. A developing bias voltage to supply the toner to the photosensitive body 230 is applied to the developing roller 240.

The supplying roller 260 supplies the toner while rotating in a predetermined direction so that the toner received in the toner storage 225 may be attached on the developing roller 240. The agitator 262 agitates the toner at a predetermined speed so that the toner in the toner storage 225 may not harden, and delivers the toner toward the supplying roller 260.

The toner layer regulator 258 has one side fixed to the housing 222 and another side contacting the developing roller 240 to regulate a height of the toner attached on the outer periphery of the developing roller 240, and to allow the toner to be charged to a predetermined polarity by friction charging. The toner layer regulator 258 may be formed of, for example, a metal plate material having elasticity. The metal plate material may be, for example, a stainless plate, a phosphor bronze plate, and a beryllium copper plate having a thickness of 0.05 to 0.2 mm.

The cleaning member 238 is installed in a predetermined portion of the housing 222 where the waste toner storage 223 is formed. One end of the cleaning member 238 is positioned to contact the photosensitive body 230 with a predetermined pressure so that toner remaining on the photosensitive body 230 after transfer may be cleaned. A first edge on one side of the cleaning member 238 can be connected to a support member 237, which is separately installed in the housing 222. A second edge on another side of the cleaning member 238 is positioned to contact the photosensitive body 230 with a predetermined pressure so that the toner remaining on the photosensitive body 230 after transfer may be cleaned.

The waste toner storage 223 is provided in the inside of the housing 222 to store the toner separated from the photosensitive body 230 by the cleaning member 238. Also, an opening 227 forming a path is located on one side of the image forming unit 200 so that light from the optical scanning unit (not illustrated) may be illuminated on the photosensitive body 230. The outer periphery of the photosensitive body 230, exposed to the outside of the electrophotographic image forming unit 200, faces the support member 114 (see FIG. 1). The support member 114 may include a transfer roller.

The image forming unit 200 illustrated in FIG. 6 is only an embodiment of the present general inventive concept, and thus the scope of the present general inventive concept is not limited by the illustrated embodiment, but can be modified in various ways. For example, the electrophotographic image forming unit 200 may have a photosensitive body and a transfer roller integral thereto.

In contrast to a conventional image forming apparatus, in an image forming apparatus according to embodiments of the present general inventive concept, an inkjet printing unit (which may be a shuttle-type printhead unit, a line-type printhead unit, or an electrophotographic image forming unit) is detachably mounted in a mounting part to perform a printing operation.

As described above, a hybrid image forming apparatus according to embodiments of the present general inventive concept can mount a printing unit appropriate for a user's printing environment in the mounting part to print an image, and thus the user's convenience can improve. Also, a user can purchase and use only a printing unit appropriate for a desired printing environment (e.g., a high-speed printing, a photo printing) without having to purchase an entirely different image forming apparatus, so that maintenance costs may be reduced. Also, since various kinds of printing units may be mounted in a single image forming apparatus, one image forming apparatus can serve various image forming apparatus functions.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A hybrid image forming apparatus, comprising:
a first printing unit detachably mountable in the hybrid image forming apparatus and having a first printhead to print an image while performing a reciprocating motion in a width direction of a printing medium;
a second printing unit detachably mountable in the hybrid image forming apparatus and having a second printhead of a length at least as long as the width of the printing medium; and
a mounting part to which each of the first printing unit and the second printing unit is detachably mountable.

2. The apparatus of claim 1, wherein the first printing unit is detachably mounted in the mounting part to be moved in the width direction of the printing medium, the first printing unit comprising:
a carriage in which the first printhead is mounted;
a guide shaft coupled to the carriage to guide a reciprocating motion of the carriage; and
a carriage moving unit to reciprocally-move the carriage in the width direction of the printing medium.

3. The apparatus of claim 2, wherein the carriage moving unit comprises:
a carriage moving motor;
a carriage moving roller to rotate by receiving a rotational force from the carriage moving motor; and
a carriage moving belt having one side to which the carriage is coupled to rotate on a continuous circuit supported by the carriage moving roller.

4. The apparatus of claim 1, further comprising:
a connector located on the mounting part and compatible with each of the first printing unit and the second printing unit to detect which of the first and second printing units is mounted in the mounting part when one of the first printing unit and the second printing unit is mounted in the mounting part.

5. A hybrid image forming apparatus, comprising:
a printhead unit detachably mountable in the hybrid image forming apparatus and having a printhead to fire ink onto a printing medium to print an image;
an image forming unit detachably mountable in the hybrid image forming apparatus to print an image on the printing medium in an electrophotographic manner; and
a mounting part to which each of the printhead unit and the image forming unit is detachably mountable.

6. The apparatus of claim 5, wherein the printhead has a length at least as long as a width of the printing medium.

7. The apparatus of claim 5, wherein the printhead prints the image while performing a reciprocating motion in a width direction of the printing medium.

8. The apparatus of claim 7, wherein the printhead unit is detachably mounted in the mounting part to be moved in the width direction of the printing medium, the printhead unit comprising:
a carriage in which the printhead is mounted;
a guide shaft coupled to the carriage to guide a reciprocating motion of the carriage; and
a carriage moving unit to reciprocally-move the carriage in the width direction of the printing medium.

9. The apparatus of claim 8, wherein the carriage moving unit comprises:
a carriage moving motor;
a carriage moving roller to rotate by receiving a rotational force from the carriage moving motor; and
a carriage moving belt having one side to which the carriage is coupled and to rotate on a continuous circuit supported by the carriage moving roller.

10. The apparatus of claim 5, further comprising:
a connector located in the mounting part and compatible with each of the printhead unit and the image forming unit to detect which of the printhead unit and the image forming unit is mounted in the mounted part when one of the printhead unit and the image forming unit is mounted in the mounting part.

11. A hybrid image forming apparatus, comprising:
a mounting unit shaped to individually-accommodate each of a plurality of printing units having different printing mechanisms; and
a detecting unit to detect when any of the plurality of printing units is mounted to the mounting unit.

12. The hybrid image forming apparatus of claim 11, wherein the plurality of printing units comprises a shuttle-type printhead unit, a line-type printhead unit, and an electrophotographic image forming cartridge.

13. The hybrid image forming apparatus of claim 12, wherein when one type of printing unit is mounted to the mounting unit, the detecting unit detects whether the one type of printing unit is the shuttle-type printhead unit, the line-type printhead unit, or the electrophotographic image forming cartridge.

14. The hybrid image forming apparatus of 12, wherein a length and a width of the mounting unit are each greater than lengths and widths of the shuttle-type printhead unit, the line-type printhead unit, and the electrophotographic image forming cartridge.

15. The hybrid image forming apparatus of claim 12, wherein a height of the mounting unit is shorter than heights of each of the array-type printhead unit, the shuttle-type printhead unit, and the electrophotographic imaging cartridge.

16. The hybrid image forming apparatus of claim 11, wherein the mounting unit includes four side walls and a space defined by the four side walls, and the mounting unit individually-accommodates each of the plurality of printing units within the space.

17. The hybrid image forming apparatus of claim 11, wherein the detecting unit comprises:
a first detecting part disposed on the mounting unit; and
a second detecting part disposed on a printing unit mounted in the mounting unit to communicate with the first detecting part.

18. The hybrid image forming apparatus of claim 11, further comprising:
a connecting unit to individually-connect each of the plurality of printing units to the mounting unit.

19. The hybrid image forming apparatus of claim 18, wherein the detecting unit is the connecting unit.

20. A hybrid image forming apparatus, comprising:
a mounting unit to accommodate two or more types of printing units having different printing mechanisms; and
a detecting unit to detect the type of the two or more types of printing units.

21. The hybrid image forming apparatus of claim 20, wherein the detecting unit detects whether the type of the two or more types of printing units is a shuttle-type printhead unit, a line-type printhead unit, or an electrophotographic image forming cartridge.

22. A hybrid image forming method, comprising:
removing a first printing unit having a first printing mechanism from a mounting unit of a hybrid image forming apparatus;
mounting a second printing unit having a second printing mechanism different from the first printing mechanism to the mounting unit; and
forming an image on a printing medium using the second printing unit mounted to the mounting unit.

23. The method of claim 22, wherein the first printing unit is a shuttle-type printhead unit, and the second printing unit is a line-type printhead unit or an electrophotographic image forming unit.

24. The method of claim 22, wherein the first printing unit is a line-type printhead unit, and the second printing unit is a shuttle-type printhead unit or an electrophotographic image forming unit.

25. The method of claim 22, wherein the first printing unit is an electrophotographic image forming unit, and the second printing unit is a line-type printhead unit or a shuttle-type printhead unit.

26. The method of claim 22, further comprising:
detecting when the second printing unit is mounted to the mounting unit before the forming of the second image using a detecting unit of the hybrid image forming apparatus.

27. The method of claim 26, further comprising:
detecting whether the second printing unit is a shuttle-type printhead unit, a line-type printhead unit, or an electrophotographic image forming unit using the detecting unit of the hybrid image forming apparatus.
